(19) United States
(12) Patent Application Publication
(10) Pub. No.: US 2015/0027793 A1
(43) Pub. Date: Jan. 29, 2015

(54) LIQUID FERTILIZER TANKS

(71) Applicant: Janzen Fabricating & Repair, LLC, Mountain Lake, MN (US)

(72) Inventor: Brian J. Janzen, Mountain Lake, MN (US)

(21) Appl. No.: 14/445,934

(22) Filed: Jul. 29, 2014

Related U.S. Application Data
(60) Provisional application No. 61/859,367, filed on Jul. 29, 2013.

(51) Int. Cl. A01C 23/00; A01C 23/04; B60P 3/22; B60P 3/30

(52) U.S. Cl. CPC A01C 23/008; B60P 3/30; A01C 23/047; B60P 3/2215
USPC 180/9.42; 220/4.12; 239/172

(57) ABSTRACT

A pair of storage tanks are mounted to a tractor on either side of a tractor frame. In one embodiment, each tank can be mounted underneath a tractor cab and between a track and the tractor frame. Furthermore, each tank extends from a leading end forming a tapered, frusto conical tip to a trailing end extending longitudinally along the tractor frame. The tanks can be supported with one or more mounting brackets assembled to the tractor frame. The tanks are fluidly coupled to plumbing and a pump that feeds liquid to a sprayer attached to the tractor.

### CROSS REFERENCE TO RELATED APPLICATIONS

This application claims benefit of U.S. Prov. App. Ser. No. 61/859,367, entitled, “Liquid Fertilizer Tanks”, filed Jul. 29, 2013, the contents of which are hereby incorporated by reference in their entirety.

### BACKGROUND OF THE INVENTION

Agricultural sprayers are used as attachments for tractors to distribute liquids such as fertilizer. The sprayers can be secured to a rear hitch of the tractor. Tanks holding the liquid to be distributed are mounted in a variety of places such as the tractor frame and rear hitch of the tractor.

### SUMMARY

A pair of storage tanks are mounted to a tractor on either side of a tractor frame. In one embodiment, each tank can be mounted underneath a tractor cab and between a track and the tractor frame. Furthermore, each tank extends from a leading end forming a tapered, frusto conical tip to a trailing end extending longitudinally along the tractor frame. The tanks can be supported with one or more mounting brackets assembled to the tractor frame. The tanks are fluidly coupled to plumbing and a pump that feeds liquid to a sprayer attached to the tractor.

### BRIEF DESCRIPTION OF THE DRAWINGS

FIG. 1 is a schematic illustration of a tractor.

FIG. 2 is a schematic diagram of components of a fertilizer distribution system.

FIG. 3 is a schematic side view of a fertilizer tank.

FIG. 4 is a rear view of an exemplary mounting bracket having a fertilizer tank mounted thereto.

### DETAILED DESCRIPTION OF THE INVENTION

Discussed below and shown in the attached figures are storage tanks mountable to a tractor. The tanks can be used to store a liquid such as fertilizer to be distributed by an agricultural sprayer. As shown, the tanks include an elongated, cylindrical body forming a frusto conical tip. Each tank is of similar or identical design and mounted to the tractor. The cylindrical design can prevent stress cracks in the tanks. In one embodiment, the tanks are formed of metal such as 10 gauge 304 stainless steel.

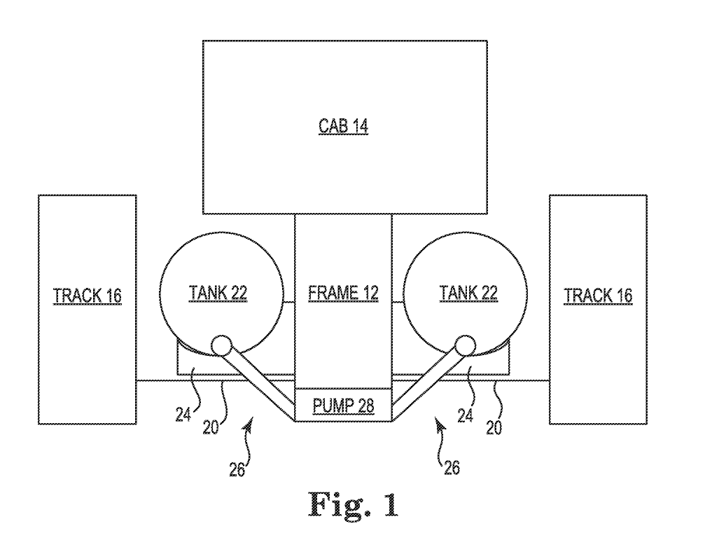

FIG. 1 is a schematic illustration of a tractor 10, which includes a frame 12, an operator cab 14 supported by the frame 12 and opposed tracks 16 positioned on either side of the frame 12. One or more axles 20 translate power from an engine (not shown) supported by the frame 12 to the tracks 16. It is worth noting that tracks 16 can also be replaced with other mechanisms such as wheels to provide motion for the tractor 10. In one embodiment, the tractor is a John Deere RT or 8000 series tractor available from Deere & Company of Moline, Ill.

Opposed tanks 22 are mounted on brackets 24 positioned on either side of frame 12 of the tractor 10, underneath operator cab 14 and inside of opposed tracks 16. The tractor 10 has not been modified from its original factory construction to accommodate the tanks 22. The tanks 22 are fluidly coupled to plumbing conduits 26 (referenced generally) and a pump 28 that delivers liquid from the tanks to a sprayer coupled with the tractor 10. In one embodiment, the tanks 22 can be mounted at an angle with respect to gravity to promote liquid entering the plumbing conduits/pump. The position and size of the tanks 22 further allow ground clearance, clearance for engine maintenance and minimal visibility loss from the operator cab 14. Additionally, the mounting of the tanks 22 can be performed without modification of factory location and factory mounts for tractor parts such as radar, ladder, tracks, etc. Respective to the tractor frame and tracks, the tanks can be positioned to evenly distribute weight of the liquid and tanks on either side of the tractor frame both in lateral and longitudinal directions.

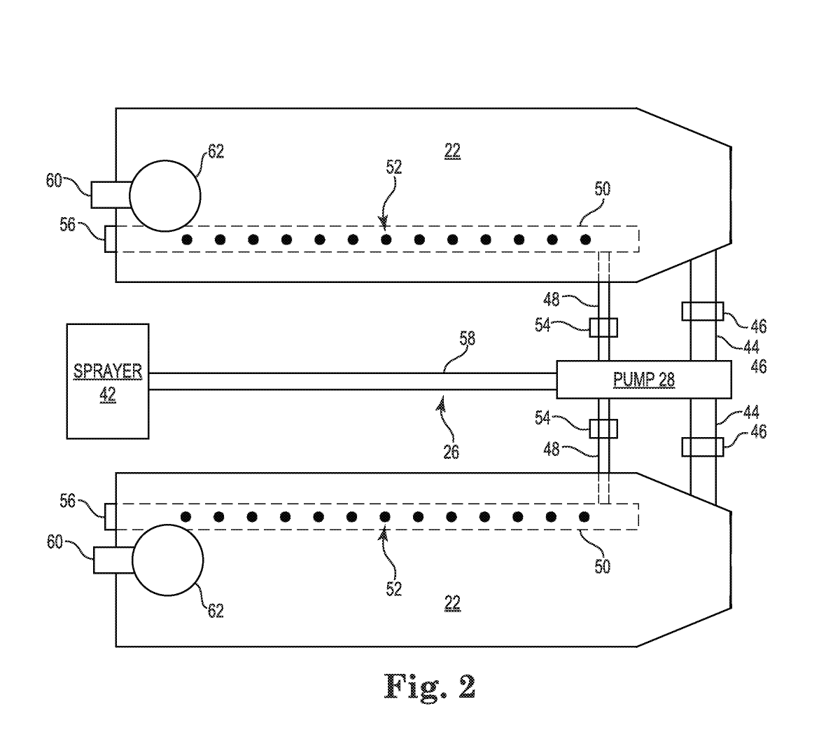

FIG. 2 is a schematic diagram of components of a fertilizer distribution system 40 for distributing fertilizer from tanks 22 to a sprayer 42. Each of the tanks 22 are connected to a primary conduit 44. Each respective primary conduit 44 is fluidly coupled with the tank 22 at a first end and the pump 28 at a second end opposite the first end. A valve 46 controls flow between the tank 22 and the pump 28. A secondary plumbing conduit 48 is connected to an agitation tube 50 positioned within the tank 22. In one embodiment, the agitation tube 50 is formed of metal such as stainless steel and welded to the interior of the tank 22. The agitation tube 50 further includes a plurality of holes 52 (e.g., distributed along a length of the tube). The pump 28 can be equipped to deliver fluid through the secondary plumbing conduit 48 to the agitation tube 50 to assist in mixing liquid stored in the tank 22. A valve 54 can further be utilized to control flow between the agitation tube 50 and the pump 28. Additionally, a cap 56 is fluidly coupled with to the agitation tube 50 of the tank 22. The cap 56 can be removed to clean out the agitation tube 50 as desired. The pump 28 also delivers fertilizer from tank 22 to sprayer 42 through a conduit 58.

Tank 22 further includes a sight tube 60 and an inspection lid 62. The sight tube 60 provides an indication as to a level of fertilizer in the tank 22. Inspection lid 64 can also be provided for an operator to view connects of the tank 22.

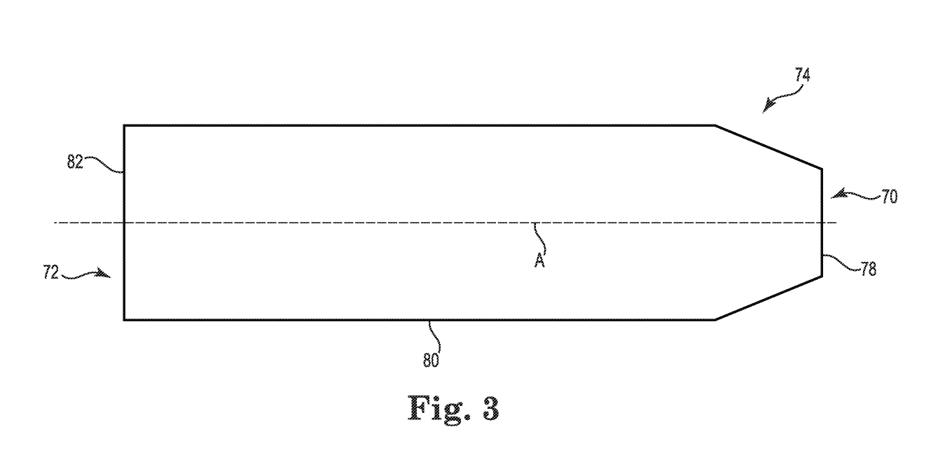

FIG. 3 is a schematic side view of one of the tanks 22. The tank 22 extends from a first, leading end 70 to a second, trailing end 72. The leading end 70 includes a frusto conical tip 74 defining an outer tapered surface 76 and a front surface 78. Extending from the frusto conical tip 74 is a cylindrical body 80 extending to a rear surface 82. The frusto conical tip 74 and the cylindrical body 80 are defined by an axis A. As discussed above, in one embodiment, upon mounting to tractor 10, the axis A is oblique with respect to a surface that supports tractor 10. In particular, the tank 22 can be mounted such that leading end 70 is closer to the surface than trailing end 72.

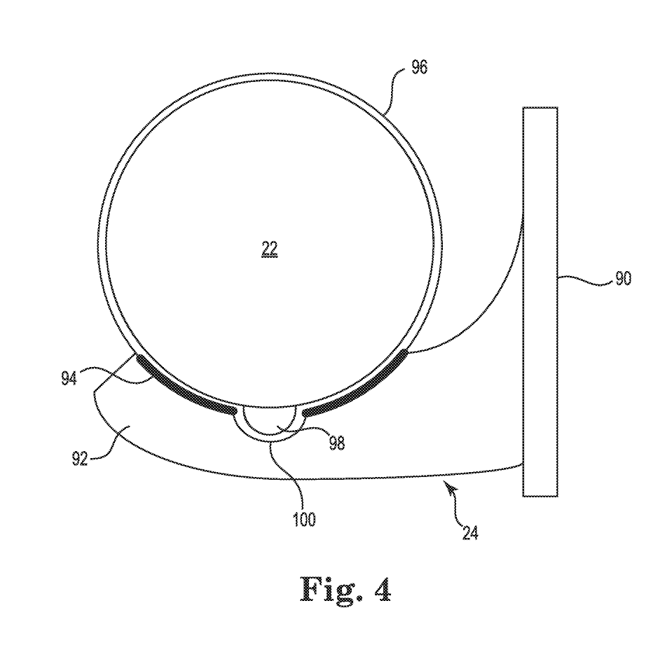

FIG. 4 is a rear view of an exemplary mounting bracket 24 useful for mounting the tank 22 to the frame 12. As illustrated, the bracket 24 includes a mounting flange 90 and a saddle 92 extending from the flange 90. The saddle 92 includes a cushion 94 (e.g., formed of a compressible polymer) to dampen movement between the bracket 24 and the tank 22. A strap 96 extends over a top of the tank 22 and connects to the bracket 24 on either side of the tank 22. The strap 96 can be tightened so as to secure the tank 22 to bracket 24. A registration mechanism or knob 98 is mounted to the tank and communicates with a recess 100 in the saddle 92 to prevent the second storage tank from rotating and/or sliding movement relative to the bracket. Together, the knob 98 and strap 96 assist in holding tank 22 securely to the tractor 10.

Although the present disclosure has been described with reference to various embodiments, workers skilled in the art will recognize that changes can be made in form and detail without departing from the spirit and scope of the present disclosure.

What is claimed is:

1. A fertilizer tank for mounting to a tractor, comprising:
an elongated cylindrical body; and
a frusto conical tip extending from the body.

2. The tank of claim 1, further comprising an agitation tube positioned in an interior of the tank.

3. The tank of claim 1, wherein the body and tip are formed of stainless steel.

4. The tank claim 1, further including a registration mechanism for coupling with a mounting bracket to prevent movement of the tank relative to the mounting bracket.

5. The tank of claim 1, further comprising a sight tube indicating a level of liquid in the tank.

6. A tractor, comprising:
a frame;
opposed tracks positioned on either side of the frame;
an operator cab supported by the frame; and
a pair of fertilizer tanks mounted on either side of the frame, each tank including an elongated cylindrical body and a frusto conical tip extending from the body.

7. The tractor of claim 6, further comprising plumbing conduits and a pump fluidly coupled to the pair of fertilizer tanks.

8. The tractor of claim 7, further comprising a sprayer fluidly coupled with the pump such that, during operation, the pump delivers fertilizer from the tanks to the sprayer.

9. The tractor of claim 8, wherein each tank further comprises an agitation tube positioned on an interior of the tank, the agitation tube fluidly coupled with the pump.

10. The tractor of claim 6, further comprising a pair of mounting brackets for each of the pair of tanks, each mounting bracket defining a saddle.

11. The tractor of claim 10, wherein each saddle includes a cushion to dampen forces between each tank and its respective mounting bracket.

12. The tractor of claim 10, further comprising a strap to secure the tank to the mounting bracket.

13. The tractor of claim 6, wherein each mounting bracket defines a recess and each tank defines a registration mechanism such that, upon mounting each tank to the mounting bracket, the registration mechanism registers with the recess.

14. The tractor of claim 6, wherein each tank is formed of stainless steel.

15. The tractor of claim 6, wherein each tank includes a sight tube indicating a level of liquid in the tank.

16. The tractor of claim 6, wherein an original factory location for a ladder, radar and tracks has not been modified.

17. The tractor of claim 6, wherein for each tank, the tip is angled in a forward direction such that a trailing end is mounted higher on the tractor that a front end.
